(19) United States
(12) Patent Application Publication
(10) Pub. No.: US 2026/0036255 A1
(43) Pub. Date: Feb. 5, 2026

(54) WIDTH-ADJUSTABLE PICATINNY RAIL BRACKET

(71) Applicant: Foshan teda photographic equipment Co., Ltd., Foshan (CN)

(72) Inventor: Xuexiong Zeng, Foshan (CN)

(21) Appl. No.: 19/179,997

(22) Filed: Apr. 15, 2025

(30) Foreign Application Priority Data
Aug. 2, 2024 (CN) 202421867088.2

(51) Int. Cl. F16M 13/02; F16B 2/12; F16B 2/18; F41G 11/00

(52) U.S. Cl. CPC F16M 13/022; F16B 2/12; F16B 2/185; F41G 11/003

(57) ABSTRACT

The present invention discloses a width-adjustable Picatinny rail bracket, which comprises a fixed bracket and a movable bracket, and a movable arm is provided on the movable bracket. By providing at least one lifting groove on a top of the fixed bracket and installing a lifting arm in the lifting groove, a clamping groove with the largest clamping width is formed by a fixed arm and the movable arm to clamp a quick-mount plate with the largest size; and when a Picatinny rail needs to be clamped, the corresponding lifting arm is controlled to be lifted up to a lifted-up state, so that the lifting arm is cooperated with the movable arm to form a clamping groove with a suitable width to clamp the Picatinny rail. The bracket has a lower entire thickness and saves materials at the same time.

### CROSS-REFERENCE TO RELATED APPLICATIONS

This is a U.S. patent application which claims the priority and benefit of Chinese Patent Application Number 202421867088.2, filed on Aug. 2, 2024, the disclosure of which is incorporated herein by reference in its entirety.

### TECHNICAL FIELD

The present invention relates to the field of brackets, in particular to a width-adjustable Picatinny rail bracket.

### BACKGROUND

A Picatinny rail, also known as an MIL-STD-1913 rail or a NATO accessory rail of STANAG 4694, is a bracket rail mainly used on firearms, which comprises a rail body arranged along a length direction of a gun and several horizontally arranged transverse grooves provided at a bottom of the rail body. A gun clip bracket is an accessory used for guns and installed on a support frame. Due to a versatile design, the gun clip bracket generally needs to be compatible with a quick-mount plate and the Picatinny rail so as to be used for installing guns of different models or accessories, such as telescopes and guns not provided with the Picatinny rail, which causes the arrangement of multiple sets of clamping positions on one gun clip bracket in a height direction to be matched with the Picatinny rail and the quick-mount plate, respectively. Referring to a US Patent with the patent No. U.S. Pat. No. 10,612,718B2, two sets of dovetail grooves with different widths are provided in the height direction to clamp the Picatinny rail and the quick-mount plate, which causes a larger thickness and a larger material consumption of the bracket.

### SUMMARY

To solve the above problems, the purpose of the present invention is to provide a Picatinny rail bracket having a smaller thickness and at least two sets of clamping widths.

A technical solution used in the present invention to solve the problems is: a width-adjustable Picatinny rail bracket, comprising:

a fixed bracket, wherein a fixed arm is provided on one side of a top of the fixed bracket, a movable bracket is provided on a side surface of the fixed bracket, a movable arm directly facing the fixed arm is provided on the movable bracket, the movable bracket is movable left and right relative to the fixed bracket, thereby making the movable arm get close to or get away from the fixed arm, and at least one lifting groove that is located between the fixed arm and the movable arm is provided on a top surface of the fixed bracket;

a lifting arm, wherein the lifting arm is inserted into the lifting groove and is liftable in the lifting groove, the lifting arm is lifted up to the top of the fixed bracket and directly faces the movable arm in a lifted-up state, and the lifting arm sinks into the lifting groove in a storage state.

As a further improvement of the above technical solution, first elastic reset members that are connected to the lifting arm and used for driving the lifting arm to be lifted up are provided in the lifting groove.

As a further improvement of the above technical solution, matching grooves are provided at a bottom of the lifting groove, and end portions of the first elastic reset members are inserted into the matching grooves.

As a further improvement of the above technical solution, at least one limiting hole that penetrates to a bottom of the fixed bracket is provided at a bottom of the lifting groove, limiting nails that pass through the limiting hole and are connected to a bottom of the lifting arm are provided at the bottom of the fixed bracket, the limiting nails comprise head portions, a size of the head portions is greater than that of the limiting hole, and when the lifting arm is in the lifted-up state, the head portions abut against a bottom surface of the fixed bracket.

As a further improvement of the above technical solution, a free groove is provided on a back surface of the lifting arm along a height direction, a fixed groove is provided on one side of a top of the free groove, a lockhole extending to a side wall of the lifting groove is provided on an outer side surface of the fixed bracket that deviates from the movable bracket, a lock rod that is movable laterally in the lockhole and has a terminal end inserted into the free groove is provided in the lockhole, a driving handle that is connected to the lock rod is provided on an outer side of the fixed bracket, and when the lifting arm is in the storage state, the fixed groove directly faces the lockhole and the terminal end of the lock rod is movable laterally into the fixed groove.

As a further improvement of the above technical solution, a communication hole extending to an inner wall of the lockhole is provided on an outer wall of the fixed bracket that deviates from the fixed groove, a second elastic reset member that abuts against the lock rod is provided in the communication hole, an end cover that abuts against an outer end of the second elastic reset member is provided at an outer end of the communication hole, and the second elastic reset member provides an elastic force for the lock rod to move in a direction towards the fixed groove.

As a further improvement of the above technical solution, a moving groove is provided at a bottom of a front end of the lock rod, a direction of the moving groove is perpendicular to a direction of the lockhole, an auxiliary hole that penetrates to a bottom of the lockhole is provided at the bottom of the fixed bracket, and a limiting block that extends into the lockhole and is inserted into the moving groove is inserted into the auxiliary hole.

As a further improvement of the above technical solution, an inclined first wall surface is provided on a surface of one side of the movable arm that is toward the fixed arm, an inclined second wall surface is provided on a surface of one side of the fixed arm that is toward the movable arm, and an inclined third wall surface is provided on a surface of one side of the lifting arm that is toward the movable arm; when the lifting arm is in the storage state, the movable arm and the fixed arm form a wide dovetail groove by combining the first wall surface and the second wall surface, and when the lifting arm is in the lifted-up state, the movable arm and the lifting arm form a narrow dovetail groove by combining the first wall surface and the third wall surface.

As a further improvement of the above technical solution, a guide rod is provided at the bottom of the lifting arm, an insertion hole that penetrates to the bottom of the fixed bracket is provided at the bottom of the lifting groove, and the guide rod is inserted into the insertion hole.

Beneficial effects of the present invention as follows: by providing the at least one lifting groove on the top of the fixed bracket and installing the lifting arm in the lifting groove, when all lifting arms are in the storage state, a clamping groove with a largest clamping width is formed by the fixed arm and the movable arm to clamp a quick-mount plate with a largest size; and when a Picatinny rail needs to be clamped, the corresponding lifting arm is controlled to be lifted up to the lifted-up state, so that the lifting arm cooperates with the movable arm to form a clamping groove with a suitable width to clamp the Picatinny rail. Through the method, the lifting arms all sink into the lifting grooves when not in use, and the corresponding lifting arm is lifted up only when necessary, so that clamping grooves formed by cooperation between all the lifting arms and the fixed arm and the movable arm are on a same horizontal plane, thus a step groove channel is not required to be provided along a height direction, and the entire bracket has a lower thickness. Moreover, since the thickness of the bracket is decreased, amounts of materials used are also decreased, and a cost is also lower.

### BRIEF DESCRIPTION OF DRAWINGS

The present invention will be further explained below in conjunction with the description of the accompanying drawings and specific embodiments.

FIG. 1 is a structural schematic diagram when a lifting arm is in a lifted-up state;

FIG. 2 is a structural schematic diagram when the lifting arm is in a storage state; FIG. 3 is a first exploded view;

FIG. 4 is a second exploded view;

FIG. 5 is a first structural schematic diagram after a fixed bracket and a movable bracket are hidden;

FIG. 6 is a second structural schematic diagram after the fixed bracket and the movable bracket are hidden; and

FIG. 7 is a structural schematic diagram of the lifting arm.

### DESCRIPTION OF EMBODIMENTS

This section will describe the specific embodiments of the present invention in detail. The preferred embodiments of the present invention are shown in the accompanying drawings. The function of the accompanying drawings is to supplement the statement of the text part of the description with graphics, so that people can intuitively and vividly understand each technical feature and overall technical solution of the present invention. However, the accompanying drawings shall not be construed as a limitation to the protection scope of the present invention.

In the statement of the present invention, it should be understood that orientation statements, such as orientation or position relationships indicated by up, down, front, back, left, right, etc., are based on the orientation or position relationships shown in the accompanying drawings and are only to facilitate the statement of the present invention and simplify the statement, rather than indicate or imply that the device or element referred to must have a specific orientation, be constructed and operate in a specific orientation, and therefore should not be understood as a limitation to the present invention.

In the statement of the present invention, “several” means one or more, “a plurality of” means two or more, “greater than”, “less than”, and “more than”, etc. are understood to exclude the original number, and above, below, within, etc. are understood to include the original number. If there is a statement of first and second, it is only for the purpose of distinguishing technical features, and cannot be understood as indicating or implying the relative importance or implicitly indicating the number of indicated technical features or implicitly indicating the order of indicated technical features.

In the statement of the present invention, unless otherwise explicitly specified, words such as setting, installation, and connection should be understood in a broad sense. Those skilled in the art can reasonably determine the specific meanings of the above words in the present invention in combination with the specific content of the technical solution.

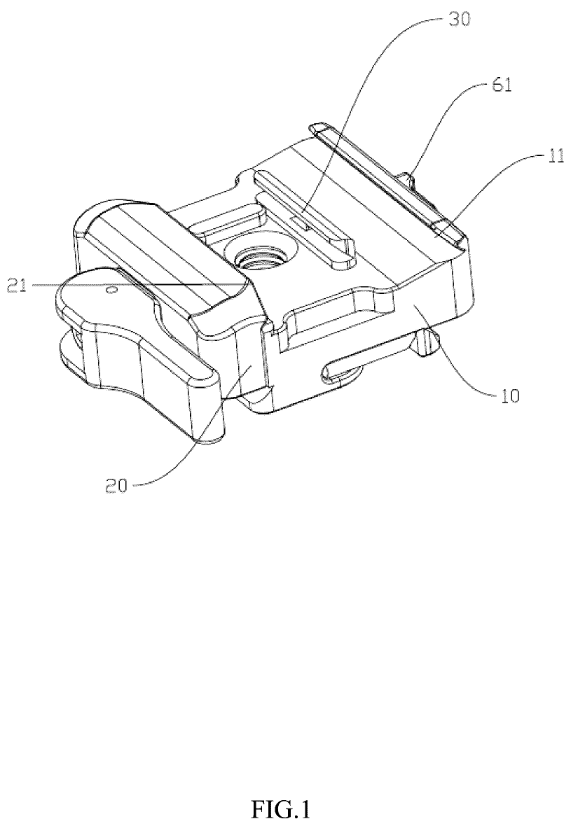

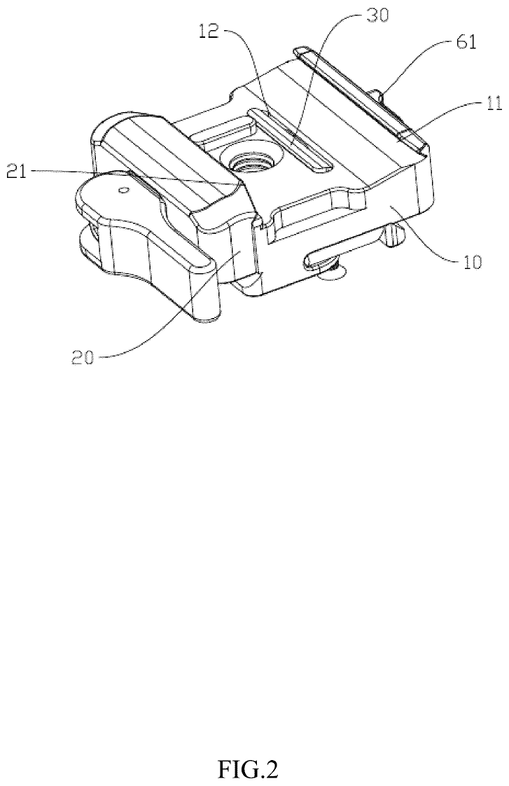

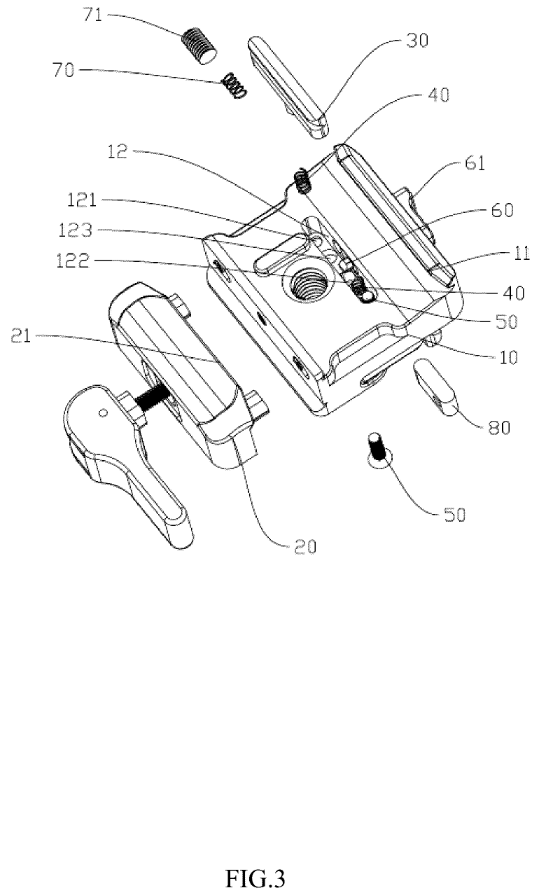

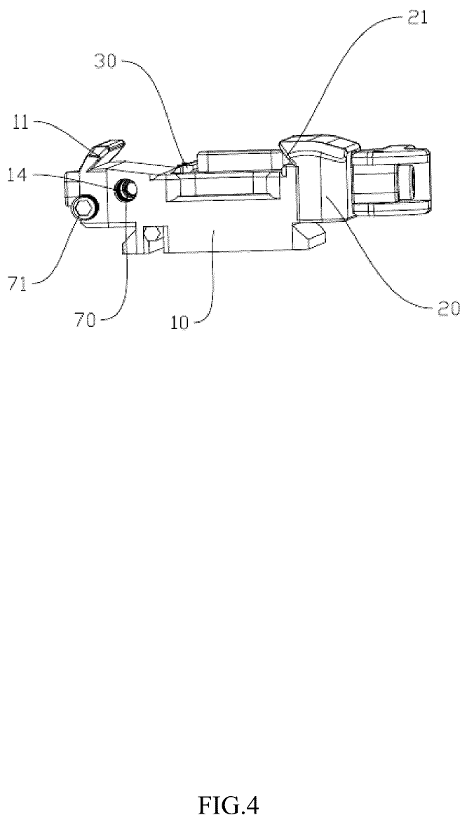

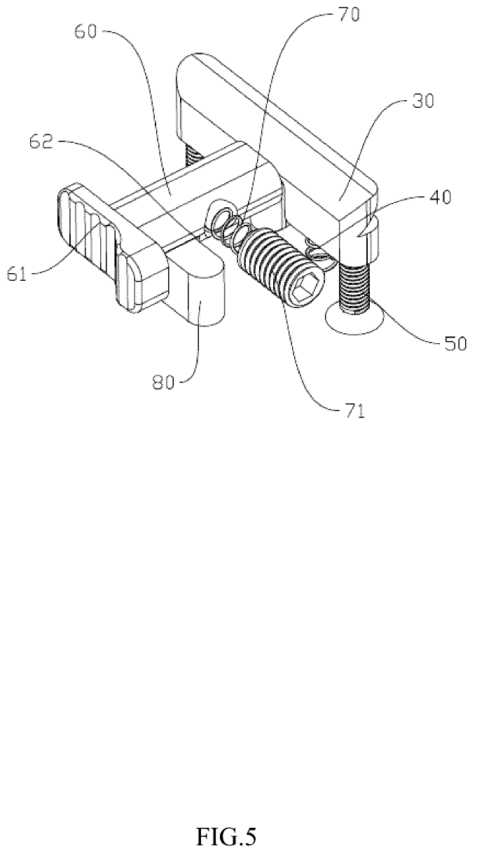

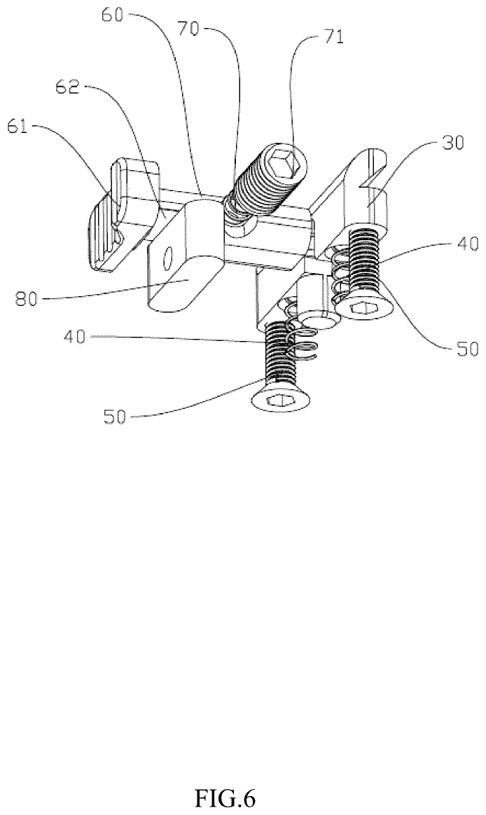

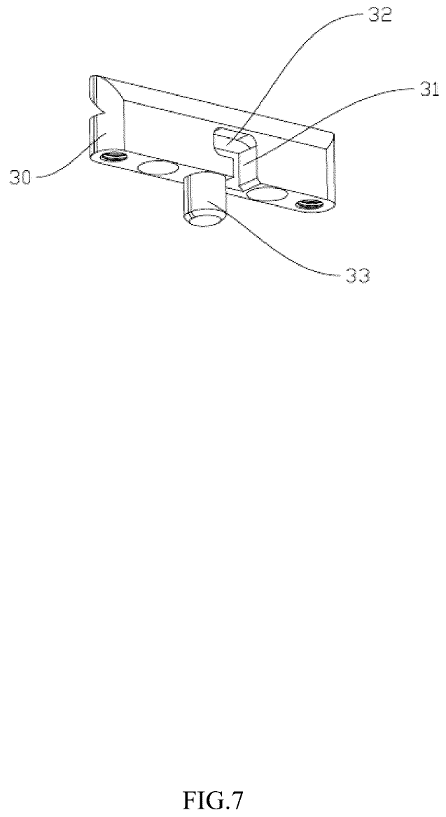

Referring to FIG. 1 to FIG. 7, a width-adjustable Picatinny rail bracket comprises:

a fixed bracket 10, wherein a fixed arm 11 is provided on one side of a top of the fixed bracket 10, a movable bracket 20 is provided on a side surface of the fixed bracket 10, a movable arm 21 directly facing the fixed arm 11 is provided on the movable bracket 20, the movable bracket 20 is movable left and right relative to the fixed bracket 10, thereby making the movable arm 21 get close to or get away from the fixed arm 11, and at least one lifting groove 12 that is located between the fixed arm 11 and the movable arm 21 is provided on a top surface of the fixed bracket 10;

a lifting arm 30, wherein the lifting arm 30 is inserted into the lifting groove 12 and is liftable in the lifting groove 12, the lifting arm 30 is lifted up to the top of the fixed bracket 10 and directly faces the movable arm 21 in a lifted-up state, and the lifting arm 30 sinks into the lifting groove 12 in a storage state.

By providing the at least one lifting groove 12 on the top of the fixed bracket 10 and installing the lifting arm 30 in the lifting groove 12, when all lifting arms 30 are in the storage state, a clamping groove with a largest clamping width is formed by the fixed arm 11 and the movable arm 21 to clamp a quick-mount plate with a largest size; and when a Picatinny rail needs to be clamped, the corresponding lifting arm 30 is controlled to be lifted up to the lifted-up state, so that the lifting arm 30 cooperates with the movable arm 21 to form a clamping groove with a suitable width to clamp the Picatinny rail. Through the method, the lifting arms 30 all sink into the lifting grooves 12 when not in use, and the corresponding lifting arm 30 is lifted up only when necessary, so that clamping grooves formed by cooperation between all the lifting arms 30 and the fixed arm 11 and the movable arm 21 are on a same horizontal plane, correspondingly a step groove channel is not required to be provided along a height direction, and the entire bracket has a lower thickness. Moreover, since the thickness of the bracket is decreased, amounts of materials used are also decreased, and a cost is also lower.

According to step levels of a width of the Picatinny rail and a width of the quick-mount plate, a set number of the lifting grooves 12 is selected correspondingly. Considering a current mainstream size, only one lifting groove 12 is preferably provided, so that a wide clamping groove is formed by the movable arm 21 and the fixed arm 11 to clamp the quick-mount plate, and a narrow clamping groove is formed by the movable arm 21 and the lifting arm 30 to clamp the Picatinny rail. Shapes of the clamping grooves may be various existing types, such as an inverted “T” shape, etc. Preferably, an inclined first wall surface is provided on a surface of one side of the movable arm 21 that is toward the fixed arm 11, an inclined second wall surface is provided on a surface of one side of the fixed arm 11 that is toward the movable arm 21, and an inclined third wall surface is provided on a surface of one side of the lifting arm 30 that is toward the movable arm 21; when the lifting arm 30 is in the storage state, the movable arm 21 and the fixed arm 11 form a wide dovetail groove by combining the first wall surface and the second wall surface, and when the lifting arm 30 is in the lifted-up state, the movable arm 21 and the lifting arm 30 form a narrow dovetail groove by combining the first wall surface and the third wall surface.

In the solution, lifting of the lifting arm 30 may be operated by a user himself. However, to simplify an operation method, preferably, first elastic reset members 40 that are connected to the lifting arm 30 and used for driving the lifting arm 30 to be lifted up are provided in the lifting groove 12, so that the lifting arm 30 is automatically bounced upward to the lifted-up state through the first elastic reset members 40. During installation of the Picatinny rail, except for the lifting arm 30 or the fixed arm 11 that is cooperated with the movable arm 21 to clamp the Picatinny rail, the remaining lifting arms 30 located below the Picatinny rail are pressed down into the lifting groove 12 by a lower end surface of the Picatinny rail so as to be in the storage state, and the quick-mount plate used also has a same installation effect.

In the solution, preferably, matching grooves 123 are provided at a bottom of the lifting groove 12, and end portions of the first elastic reset members 40 are inserted into the matching grooves 123 to facilitate installation of the first elastic reset members 40. Preferably, the first elastic reset members 40 are first reset springs, and in other embodiments, may also be elastic rubber columns, two mutually exclusive magnets, etc.

For further optimization, preferably, at least one limiting hole 121 that penetrates to a bottom of the fixed bracket 10 is provided at a bottom of the lifting groove 12, limiting nails 50 that pass through the limiting holes 121 and are connected to a bottom of the lifting arm 30 are provided at the bottom of the fixed bracket 10, the limiting nails 50 comprise head portions, a size of the head portions is greater than that of the limiting hole 121, and when the lifting arm 30 is in the lifted-up state, the head portions abut against a bottom surface of the fixed bracket 10, so that the lifting arm 30 is limited to be lifted up to a maximum height on the top surface of the fixed bracket 10 through the limiting nails 50. Meanwhile, by means of the structure, the lifting arm 30 and the lifting groove 12 are also enabled to commonly fix the first elastic reset members 40.

In other embodiments, glue is also possible to be selected to bond two ends of the first reset springs to a bottom surface of the lifting groove 12 and a bottom surface of the lifting arm 30, respectively, thereby also playing the role of limiting the lifting arm 30.

For further optimization, preferably, a free groove 31 is provided on a back surface of the lifting arm 30 along a height direction, a fixed groove 32 is provided on one side of a top of the free groove 31, a lockhole 13 extending to a side wall of the lifting groove 12 is provided on an outer side surface of the fixed bracket 10 that deviates from the movable bracket 20, a lock rod 60 that is movable laterally in the lockhole 13 and has a terminal end inserted into the free groove 31 is provided in the lockhole 13, a driving handle 61 that is connected to the lock rod 60 is provided on an outer side of the fixed bracket 10, and when the lifting arm 30 is in the storage state, the fixed groove 32 directly faces the lockhole 13 and the terminal end of the lock rod 60 is movable laterally into the fixed groove 32. Through the structure, in a normal state, the lifting arm 30 is automatically bounced upward to the lifted-up state under the action of the first reset springs. When the lifting arm 30 is pressed down to the storage state, the lock rod 60 is moved through the driving handle 61 to make the lock rod 60 laterally enter the fixed groove 32, thereby fixing the lifting arm 30 in the storage state.

Further optimization, preferably, a communication hole 14 extending to an inner wall of the lockhole 13 is provided on an outer wall of the fixed bracket 10 that deviates from the fixed groove 32, a second elastic reset member 70 that abuts against the lock rod 60 is provided in the communication hole 14, an end cover 71 that abuts against an outer end of the second elastic reset member 70 is provided at an outer end of the communication hole 14, and the second elastic reset member 70 provides an elastic force for the lock rod 60 to move in a direction toward the fixed groove 32, so that when the lifting arm 30 sinks into the lifting groove 12 to be in the storage state, the lock rod 60 is automatically bounced into the fixed groove 32 through a second reset device.

For further optimization, preferably, a moving groove 62 is provided at a bottom of a front end of the lock rod 60, a direction of the moving groove 62 is perpendicular to a direction of the lockhole 13, an auxiliary hole that penetrates to a bottom of the lockhole 13 is provided at the bottom of the fixed bracket 10, and a limiting block 80 that extends into the lockhole 13 and is inserted into the moving groove 62 is inserted into the auxiliary hole. The lock rod 60 is limited through cooperation between the limiting block 80 and the auxiliary hole, so that the lock rod 60 can be prevented from disengaging during movement. In other embodiments, the lock rod 60 can also be prevented from disengaging by providing an anti-detachment sleeve that is sleeved on an outer side of the driving handle 61 on the outer side of the fixed bracket 10.

In other embodiments in which the first elastic reset members 40 are not used for controlling the lifting arm 30, a groove body may also be provided on one side of a lower portion of the free groove 31, so that when the lifting arm 30 is in the lifted-up state, the lifting arm 30 also enters the groove body through the lock rod 60 to be locked in the lifted-up state. In other embodiments, a position of the lifting arm 30 may also be controlled by controlling a friction force between the lifting arm 30 and an inner wall of the lifting groove 12.

In other embodiments, an abutting bolt that abuts against a surface of the lifting arm 30 may also be provided on the fixed bracket 10 to lock the position of the lifting arm 30.

In the solution, preferably, a guide rod 33 is provided at the bottom of the lifting arm 30, an insertion hole 122 that penetrates to the bottom of the fixed bracket 10 is provided at the bottom of the lifting groove 12, and the guide rod 33 is inserted into the insertion hole 122.

The above are only preferred embodiments of the present invention, and are not intended to limit the patent scope of the present invention. Under the inventive concept of the present invention, equivalent structural transformations made using the contents of the description and drawings of the present invention, or directly or indirectly used in other relevant technical fields are all included in the patent protection scope of the present invention.

What is claimed is:

1. A width-adjustable Picatinny rail bracket, wherein the width-adjustable Picatinny rail bracket comprises:
a fixed bracket (10), wherein a fixed arm (11) is provided on one side of a top of the fixed bracket (10), a movable bracket (20) is provided on a side surface of the fixed bracket (10), a movable arm (21) directly facing the fixed arm (11) is provided on the movable bracket (20), the movable bracket (20) is movable left and right relative to the fixed bracket (10), thereby making the movable arm (21) get close to or get away from the fixed arm (11), and at least one lifting groove (12) that is located between the fixed arm (11) and the movable arm (21) is provided on a top surface of the fixed bracket (10);
a lifting arm (30), wherein the lifting arm (30) is inserted into the lifting groove (12) and is liftable in the lifting groove (12), the lifting arm (30) is lifted up to the top of the fixed bracket (10) and directly faces the movable arm (21) in a lifted-up state, and the lifting arm (30) sinks into the lifting groove (12) in a storage state.

2. The width-adjustable Picatinny rail bracket according to claim 1, wherein:
first elastic reset members (40) that are connected to the lifting arm (30) and used for driving the lifting arm (30) to be lifted up are provided in the lifting groove (12).

3. The width-adjustable Picatinny rail bracket according to claim 2, wherein:
matching grooves (123) are provided at a bottom of the lifting groove (12), and end portions of the first elastic reset members (40) are inserted into the matching grooves (123).

4. The width-adjustable Picatinny rail bracket according to claim 1, wherein:
at least one limiting hole (121) that penetrates to a bottom of the fixed bracket (10) is provided at a bottom of the lifting groove (12), limiting nails (50) that pass through the limiting holes (121) and are connected to a bottom of the lifting arm (30) are provided at the bottom of the fixed bracket (10), the limiting nails (50) comprise head portions, a size of the head portions is greater than that of the limiting hole (121), and when the lifting arm (30) is in the lifted-up state, the head portions abut against a bottom surface of the fixed bracket (10).

5. The width-adjustable Picatinny rail bracket according to claim 2, wherein:
a free groove (31) is provided on a back surface of the lifting arm (30) along a height direction, a fixed groove (32) is provided on one side of a top of the free groove (31), a lockhole (13) extending to a side wall of the lifting groove (12) is provided on an outer side surface of the fixed bracket (10) that deviates from the movable bracket (20), a lock rod (60) that is movable laterally in the lockhole (13) and has a terminal end inserted into the free groove (31) is provided in the lockhole (13), a driving handle (61) that is connected to the lock rod (60) is provided on an outer side of the fixed bracket (10), and when the lifting arm (30) is in the storage state, the fixed groove (32) directly faces the lockhole (13) and the terminal end of the lock rod (60) is movable laterally into the fixed groove (32).

6. The width-adjustable Picatinny rail bracket according to claim 5, wherein:
a communication hole (14) extending to an inner wall of the lockhole (13) is provided on an outer wall of the fixed bracket (10) that deviates from the fixed groove (32), a second elastic reset member (70) that abuts against the lock rod (60) is provided in the communication hole (14), an end cover (71) that abuts against an outer end of the second elastic reset member (70) is provided at an outer end of the communication hole (14), and the second elastic reset member (70) provides an elastic force for the lock rod (60) to move in a direction towards the fixed groove (32).

7. The width-adjustable Picatinny rail bracket according to claim 5, wherein:
a moving groove (62) is provided at a bottom of a front end of the lock rod (60), a direction of the moving groove (62) is perpendicular to a direction of the lockhole (13), an auxiliary hole that penetrates to a bottom of the lockhole (13) is provided at the bottom of the fixed bracket (10), and a limiting block (80) that extends into the lockhole (13) and is inserted into the moving groove (62) is inserted into the auxiliary hole.

8. The width-adjustable Picatinny rail bracket according to claim 1, wherein:
an inclined first wall surface is provided on a surface of one side of the movable arm (21) that is toward the fixed arm (11), an inclined second wall surface is provided on a surface of one side of the fixed arm (11) that is toward the movable arm (21), and an inclined third wall surface is provided on a surface of one side of the lifting arm (30) that is toward the movable arm (21); when the lifting arm (30) is in the storage state, the movable arm (21) and the fixed arm (11) form a wide dovetail groove by combining the first wall surface and the second wall surface, and when the lifting arm (30) is in the lifted-up state, the movable arm (21) and the lifting arm (30) form a narrow dovetail groove by combining the first wall surface and the third wall surface.

9. The width-adjustable Picatinny rail bracket according to claim 1, wherein:
a guide rod (33) is provided at the bottom of the lifting arm (30), an insertion hole (122) that penetrates to the bottom of the fixed bracket (10) is provided at the bottom of the lifting groove (12), and the guide rod (33) is inserted into the insertion hole (122).
